(19) United States
(12) Patent Application Publication
(10) Pub. No.: US 2012/0067924 A1
(43) Pub. Date: Mar. 22, 2012

(54) AIRLESS PUMP DISPENSING SYSTEM WITH MULTI-LOBE RING SEAL

(76) Inventor: David M. Deans, Woodland Hills, CA (US)

(21) Appl. No.: 12/887,378

(22) Filed: Sep. 21, 2010

(51) Int. Cl. B67D 7/00; F16J 15/32; B65D 88/54

(52) U.S. Cl. 222/256; 222/1; 277/436; 222/321.1

(57) ABSTRACT

Method and apparatus for dispensing a fluid using a dispensing container employing an airless pump, which may employ abstract or non-cylindrical shapes. The airless pump uses a chamber enclosing a fluid with a piston comprising a surface of the chamber. The chamber has an interior volume with a substantially uniform cross section along a height of the chamber, to which the piston is conformed allowing the piston to transverse the height of the chamber. The gaps between the piston and the interior of the chamber are sealed with a multi-lobe ring seal.

### BACKGROUND OF THE INVENTION

1. Field of the Invention

The present invention generally relates to airless dispensing pumps, and more specifically, but not exclusively, concerns an airless dispensing pump that is able to efficiently pump fluids while at the same time minimizes leakage and exposure of the contents to air and contamination. The invention has particular utility in connection with airless dispensing pumps for personal care products and will be described in connection with such utility, although other utilities are contemplated.

2. Description of Related Art

Airless type pumps have been developed for a wide range of applications including dispensing personal care products, such as skin creams, skin lotions, toothpaste, hair gels hand lotions, face creams, wrinkle serums, acne treatments, shampoos, conditioners and liquids for a host of applications. An airless pump typically refers to a pump that provides pumping of a substance from a container in essentially a single direction without permitting reverse (intake) flow of air via the pump. That is, as product is pumped from the container, the pumped product is not replaced with a corresponding volume of air through the pump. In addition to preventing reverse intake flow of “air” via the pump, an “airless pump” typically does not allow intake of any other substances to replace the volume of product pumped out of the container. For example, an “airless pump” could include a one-way valve, such as a check valve. Airless type pumps have also used in applications where the thick viscosity of a product prohibits conventional type dispensing that utilizes a hollow tube attached to a pump and after a small amount of the semi-liquid product (like toothpaste) is evacuated a void is created at the end of the tube preventing additional product from being dispensed.

There are two types of airless pumps. One such type is described in U.S. Pat. No. 4,093,123. The interior of the airless pump container is divided into a first, upper chamber for the product and a second, lower chamber for the propellant, by a free-floating piston which is movable along the interior of the container to maintain the upper chamber pressurized from the pressure of the propellant in the lower chamber as the liquid is expelled. As the liquid is dispensed from the upper chamber, the piston moves upwardly, contracting the volume of the upper chamber and increasing the volume of the lower chamber under the influence of the pressure of the propellant therein. The piston may include a pair of upper and lower O-ring seals mounted in grooves or recesses in the piston or it may use a molder piston typically made from a soft and flexible resin such as polypropylene.

A second type of airless pump includes a pump container divided into a first, upper chamber for the product and a second, lower chamber vented to the atmosphere by a free-floating piston which is moveable along the interior of the container. A one way pump creates a vacuum in the upper chamber, draining product into the pump chamber where it may be expelled from a pump nozzle, and lifting the free-floating pistons to fill the void created as the product is drawn from the upper chamber.

There are several problems associated with producing and using such devices. First of all, the seal between the piston and the interior surface of the container often is insufficient. O-ring seals of the prior art have a parting line on the sealing surface. Accordingly, any irregularity, such as a corner in a non-circular shaped container or a longitudinal weld line which produces a thickening, is detrimental to forming a leak proof seal.

Additionally, O-ring seals are subject to spiral failure. Under certain conditions, segments of the O-ring slide and other segments of the O-ring roll simultaneously. The twisted seal is forced by pressure into the sharp corner at the clearance gap. Rapid stress-aging can cause a rupture of the O-ring to start adjacent the clearance gap. Motion of the O-ring causes the rupture to penetrate about half way through the cross-section. Thus, when the O-ring is removed, it returns to its original shape and the rupture appears as a tight spiral around the cross section. One of the primary causes of spiral failure is slow speeds of the piston where the sliding, or running, seal friction is very high relative to the break out friction. Pistons in airless pumps used for personal care products typically are moved a small fraction of an inch at a time over several months of use, exacerbating the problem of spiral failure in O-ring seals. Molded or formed pistons made from polypropylene also have their shortcomings. These pistons work well for applications where the container has round or cylindrical walls, however, they typically are not reliable when used for applications where the piston contact walls are a non-cylindrical surface such as a square, heart shape, triangular or other shape including free form shapes.

Many personal care products, such as skin creams, skin lotions, toothpaste and hair gels, as well as food sauces, and the like deteriorate rapidly when placed in contact with air, and so it is important to prevent air from entering the package and contacting the product when dispensing the product. A tight seal between the piston and the container also is important to ensure that the force driving the piston actually moves the piston, instead of merely pushing or pulling air into the chamber in which the liquid is housed.

JPA 2003-22462 discloses an airless pump container which includes a container body for holding fluid and an airless pump. The invention of JPA 2003-22462 includes a hermetic feature between a bottom flap and the inner wall of the container body without increasing a sliding friction, by providing lower and upper inclined arms of resilient material with the bottom flap at the peripheral thereof contacting with the inner wall of the container body (see FIG. 3(A) thereof). Such a complicated structure is difficult to manufacture and assemble and accordingly is more costly to produce.

### BRIEF SUMMARY OF THE INVENTION

The present invention provides, among other things, a dispenser for storing a product, for example a cosmetic product, and for dispensing it using a piston, which overcomes the aforesaid and other problems discussed hereinabove with reference to conventional devices.

A particular object of the invention is to provide a dispenser of the piston type which offers a better leak proof seal in comparison to conventional devices.

Another object of the invention is to provide a dispenser of the piston type that allows a leak proof seal in a container in a variety of non-circular shapes, for example containers having an oval, square, triangular or other polygon-shaped cross section, or other cross-section shape including free form shape.

Another object of the invention is to provide a dispenser of the piston type which is less expensive to manufacture in comparison to conventional devices.

It should be understood that the invention could still be practiced without performing one or more of the preferred objects and/or advantages set forth above. Still other objects will become apparent after reading the following description of the invention.

The above and other objects may be achieved using devices involving a container for dispensing a fluid, such as a cosmetic liquid. The container has a first chamber that has an interior with a substantially uniform cross section along a height of the first chamber. A fluid is enclosed within the interior of the first chamber. A release valve is in fluid communication with the first chamber to release the fluid contents of the first chamber upon command. The fluid is propelled by a piston that makes up a surface of the first chamber and separates the first chamber from a second chamber. The piston has a cross section shape conforming to the substantially uniform cross section along the height of the first chamber. A channel is formed in the periphery of the piston, in which is situated a multi-lobe ring seal such as a Quad-ring™ or X-ring that seals a gap between the interior of the first chamber and the periphery of the piston and allows the piston to transverse the height of the first chamber. Multi-lobe ring seals can have 2, 3, 4, 5 or more lobes. Multi-lobe ring seals such as Quad-rings™, or X-rings which are a preferred form of multi-lobe seals, have a four-lobed cross-sectional design, which offer twice the sealing surface in comparison to a standard O-ring. The double seal action requires less “squeezing force” to maintain an effective seal. Also, multi-lobe or X-ring parting lines are between lobes, away from the sealing surface, thus eliminating the problems of leakage often resulting from a parting line's irregular surface as formed on conventional O-rings. Multi-lobe or X-rings traditionally have been used in high pressure rotary seal applications but heretofore have not been used in airless pumps or the like.

The valley of the multi-lobe or X-ring seal may contain a lubricant, such as an oil, a cream, or a small amount of the fluid to be dispensed and the piston may include additional channels, in which another multi-lobe or X-ring seal or a lubricant may be housed. The multi-lobe or X-ring seal of the invention allows the chamber to have a cross section shape of virtually any design including a polygon having corners. Of course, the corners of the polygon should be at least partially rounded.

Alternately, if desired, the second chamber of the container may be in fluid contact with ambient air to avoid a vacuum when the volume of the second chamber expands as the piston transverses the height of the first chamber.

Alternatively, if desired, the piston may be driven at least in part by a spring, a propellant, preferably air, coupled to the second chamber by an intake valve, or negative pressure exerted by the release valve mechanism.

The piston of the container may have a face surface in which a pocket is provided to accommodate the release valve as the piston approaches the release valve. When the piston is sufficiently thin, the pocket may extend beyond the bottom surface of the piston.

The above and other objects may be achieved using methods involving sealing the space between a piston and an interior of a chamber having a substantially uniform cross section along a height of the chamber by providing the piston with a shape that corresponds to the cross section of the chamber. The piston is provided with a channel configured to accommodate a multi-lobe seal such as an X-ring seal that is in turn sized to correspond to the size of the piston. The multi-lobe or X-ring seal is placed in the channel in the piston, and the piston is placed in the chamber. The multi-lobe or X-ring seal allows the cross section of the chamber to be substantially any shape, including a polygon having corners, provided the corners are slightly rounded, in part, to facilitate the seal. A lubricant may also be provided to the valley(s) of the multi-lobe or X-ring seal.

Alternatively, the multi-lobe or X-ring seal may be formed in-situ in the channel using a two shot or bi-injection molding process. Two shot or bi-injection molding processes have an advantage over pre-formed multi-lobe or X-ring seals in terms of ease of assembly and the ability to manufacture free-form shapes having non-uniform radii or differences in center-to-edge dimensions. A lubricant may be placed in the valley(s) of the multi-lobe or X-ring seal, such as an oil, a cream, or a small amount of the fluid to be dispersed. A release valve is also provided in fluid communication with the first chamber to release the fluid contents of the first chamber upon command. A user operates the release valve to drive the piston and expel the fluid.

Aspects and applications of the invention presented here are described below in the drawings and detailed description of the invention.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 is a vertical sectional view of an embodiment of the invention;

FIG. 2a is a vertical sectional view of the piston, in accordance with an embodiment of the invention shown in FIG. 1;

FIG. 2b is a cross-sectional view of the piston of the dispenser of FIG. 1 along line a-b in FIG. 2a, showing the groove in which a multi-lobe seal in the form of an X-ring seal is situated;

FIG. 3 is an open perspective view of a dispenser, in accordance with an alternative embodiment of the invention;

FIG. 4 is a cross-sectional view of a multi-lobe seal in the form of an X-ring seal to be used in the dispenser of FIGS. 1 and 3; and

FIG. 5 is an exploded view and FIG. 6 a cross-sectional view illustrating an alternative embodiment of the present invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. The full scope of the inventions is not limited to the examples that are described below.

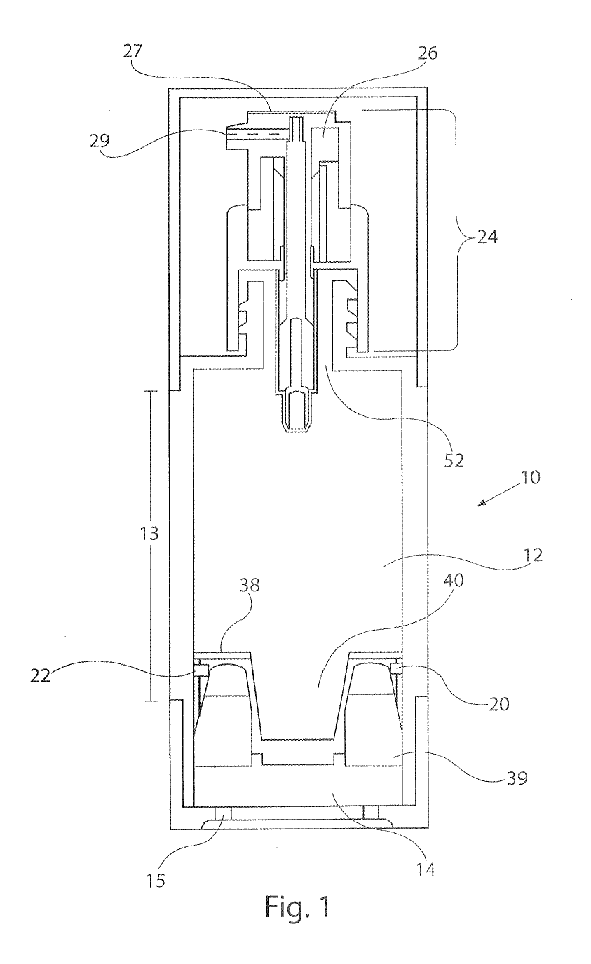

Referring initially to FIGS. 1-3, there is shown therein a particular embodiment in accordance with the present invention comprising a hollow container 10 having an interior shape 11. As shown, the interior shape 11 has a substantially square cross section, but any other shape may be used, such as a circular, oval, triangular or any other shape cross section. Container 10 comprises a first liquid chamber 12 and a second chamber 14. Chamber 14 is in fluid communication with ambient air through an air hole 15

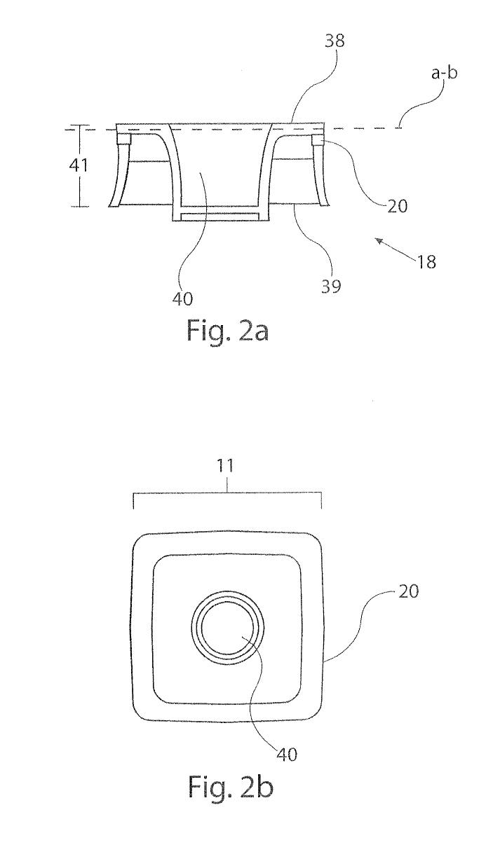

A free-floating piston 18, seen in detail in FIGS. 2a and 2b, is positioned within the container 10 in preparation for filling and during use, and serves to divide the liquid chamber 12 from the chamber 14. Piston 18 includes at least one peripheral groove 20. Multi-lobe seals such as X-ring seals 22 are used with the piston 18 to effectively seal the lower chamber 14 against passage of the fluid contents from chamber 12 and also against the passage of the air or other propellant therein past the piston 18. The corners of the interior shape 11 may be at least partially rounded to facilitate a complete seal between the piston 18 and the interior of the container 10.

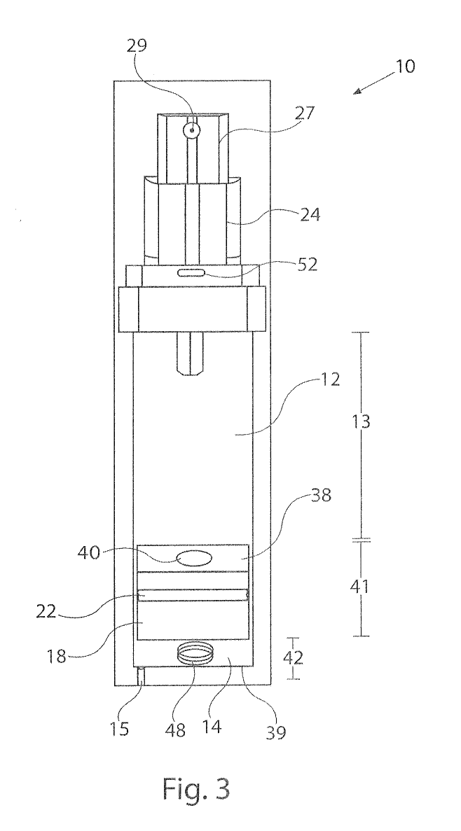

A dispensing pump 24 (FIGS. 1 and 3) is arranged to be mounted on top of the container 10. The dispensing pump 24 is removed from the container 10 to permit filling of the liquid chamber 12 or for cleaning or for any other purpose. An additional multi-lobe seal such as an X-ring seal (not shown) may be included inside the dispensing pump 24 for providing an effective seal between the dispensing pump 24 and the container 10. A spring driven return press button 27 is mounted on top of the dispensing pump 24 and when depressed causes a negative pressure to form in chamber 12 of container 10. This causes the piston to rise forcing the liquid contents of the upper chamber 12 of the container 10 through nozzle 29 at the will of the user. The dispensing pump 24 is shown in FIG. 1 as including a press button 27 and nozzle 29 for directing the pump output from the container 10 when the pump 26 is pressed for release.

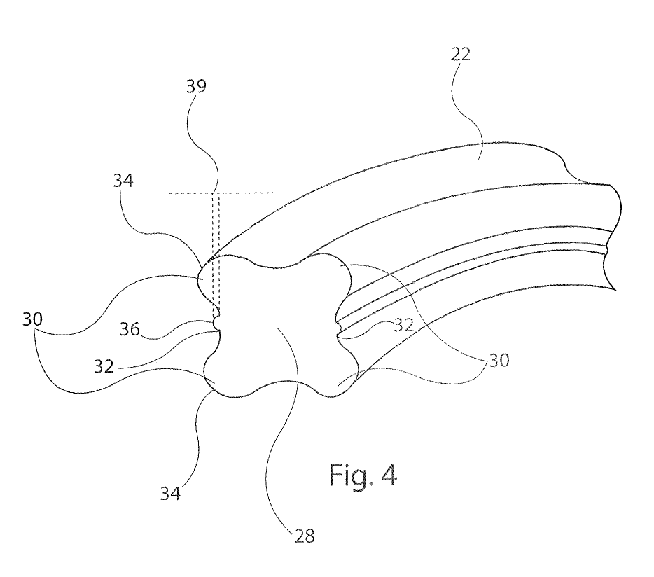

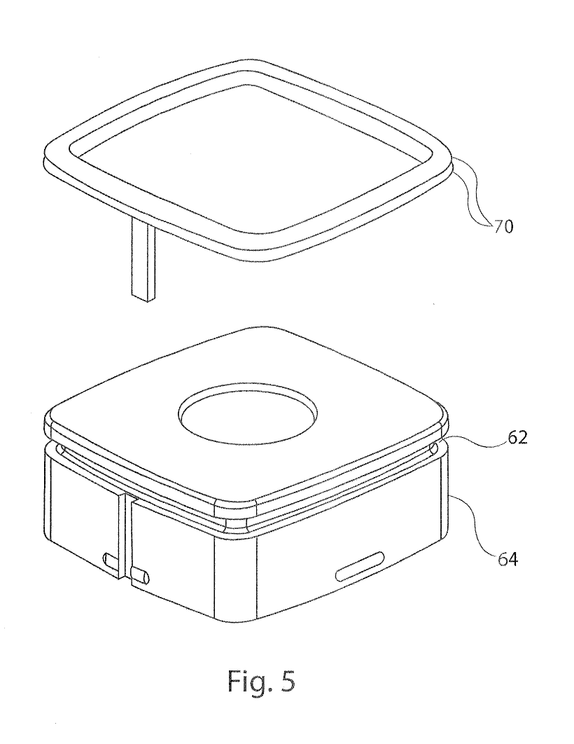

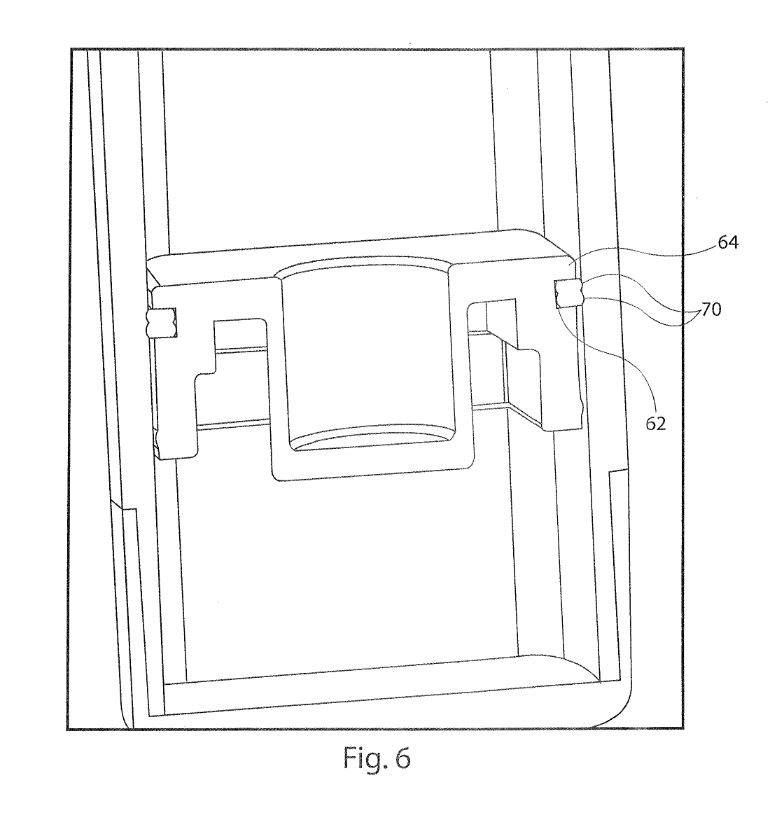

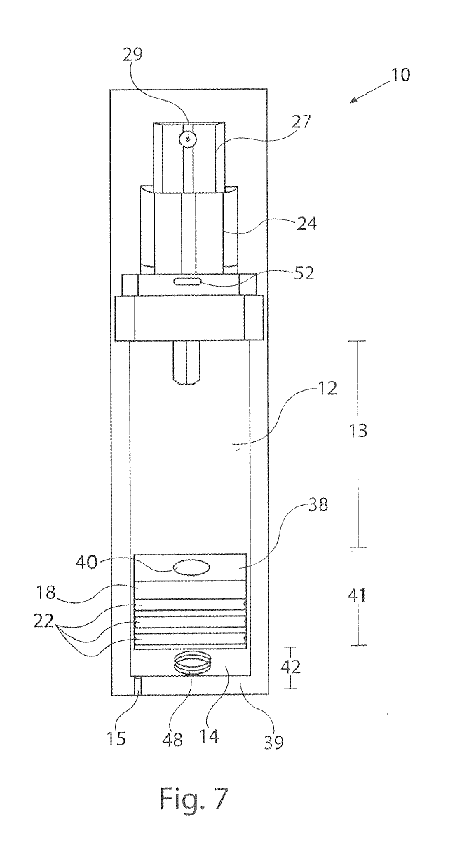

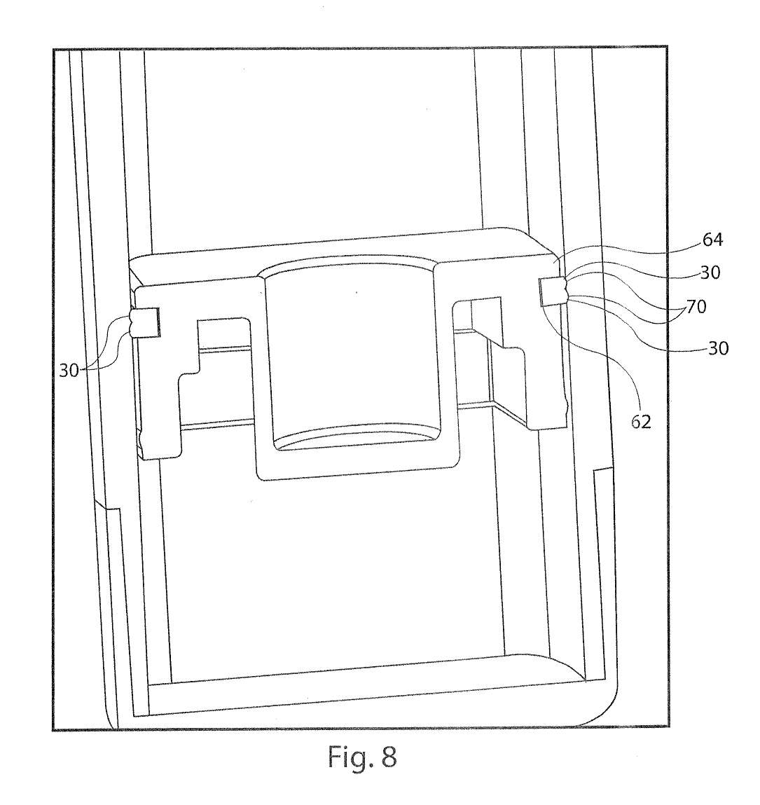

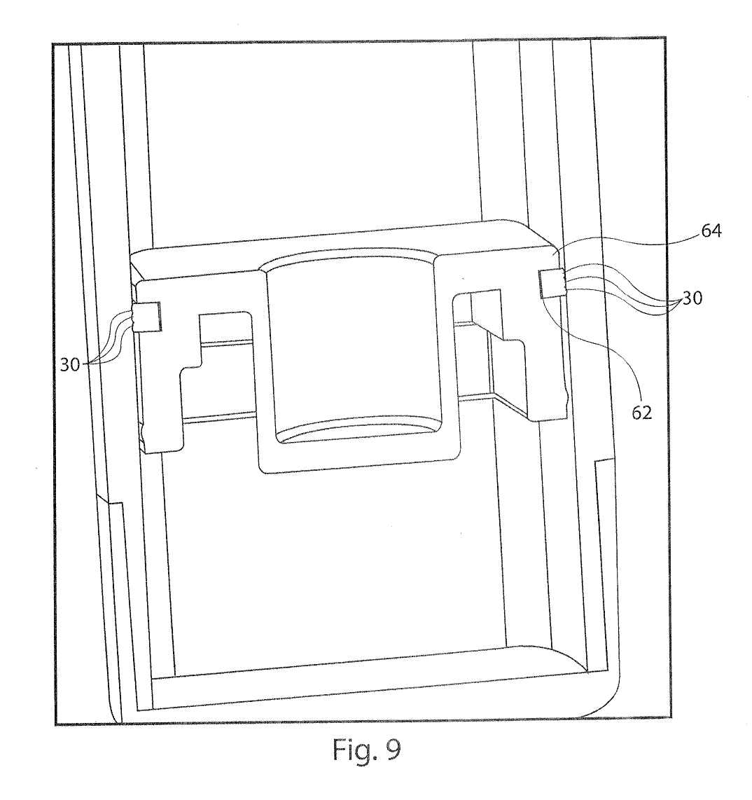

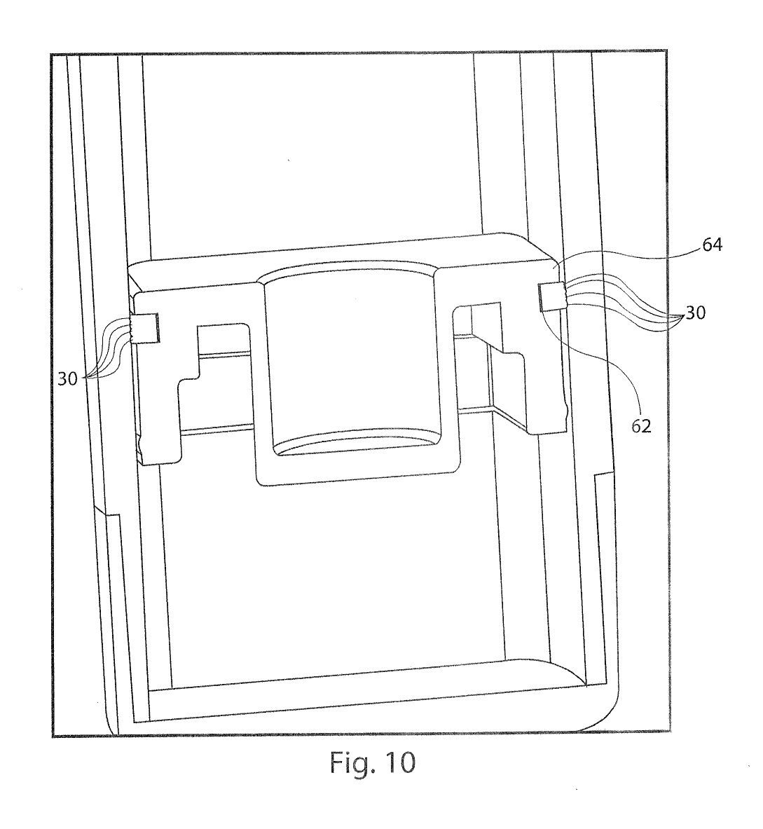

Multi-lobe seal 22 is shown in more detail in FIG. 4. Multi-lobe seal 22 includes an x-shaped cross section 28. The x-shaped cross section 28 is comprised of four lobes 30, with a valley 32 lying between adjacent lobes 30. Each lobe 30 of the multi-lobe seal 22 has a sealing surface 34 at a substantially distal extreme of the lobe 30. The valleys 32 between adjacent lobes 30 include a parting line 36 running the length of substantially the center of the valleys 32. If desired, a ridge or extension 39 may extend from the parting line 36. Unlike O-rings, where the parting line is on the sealing surface of the seal, the parting lines 36 of the multi-lobe seal lie between lobes 30 and away from the sealing surface 34.

Surprisingly, the use of a multi-lobe seal 22 allows effective sealing of a shape other than a continuous circle or oval shape. The lobes 30 of the of the multi-lobe seal extending beyond the parting line 36 allow the multi-lobe seal 22 to fill corner gaps and inconsistencies in a way that is not possible with a conventional O-ring seal. Accordingly, multi-lobe seals 22 may be substantially circular, oval, triangular or any other polygon-shaped cross section or other shape configured to conform to the cross sectional shape of the piston 18. A supply of lubricant, such as oil, cream, or a small amount of product may be held in the valley 32 of the multi-lobe seal 22 to lubricate the movement of the piston 18 and to improve the quality of the seal between the multi-lobe seal 22 and the container 10.

A multi-lobe seal may be formed using a bi-injection process. For bi-injection applications a grove is tooled in the piston mold and after the piston is formed and sufficiently cooled the tool is rotated to a secondary position and a suitable resin, such as silicon gasket material is injected which forms the multi-lobe gasket or seal. This process has certain advantages over standard pre-formed multi-lobe seals such as better sealing characteristics for small radius shapes and simplifies assembly issues. Also, since the multi-lobe seal of a bi-injected gasket is anchored to the peripheral grove 20 there in no tendency for the bi-injected gasket or seal to twist or become out of alignment. Additionally the contact surface for the piston ring seal groove is formed of resin as opposed to the inner lobes of a pre-formed ring seal such as an X-ring seal so the sealing characteristics are somewhat better.

The piston 18 is configured to substantially conform to the cross section of the interior shape 11 of the container 10. The piston also includes a face surface 38, having a shaped pocket 40. The pocket 40 is shaped to accommodate pump 24 as piston 18 approaches the top of container 10 during use. This allows the user to dispense the entire product from container 10. The thickness 41 of the piston need only be great enough to accommodate the peripheral groove 20 for the multi-lobe ring seal 22. The pocket 40 may extend beyond the bottom surface 39 of the piston in some instances. The piston 18 is shown as having a single peripheral groove 20 for receiving the multi-lobe ring seal 22. It is contemplated, however, that additional grooves and multi-lobe ring seals 22 may be provided for redundant or additional sealing of the piston 18 inside the container 10. Additionally, an intermediate lubrication groove may be provided for receiving and holding a supply of a lubricant for the piston, such as oil, cream or a small amount of the product to be dispensed. The groove 20 may be shaped to allow for easy insertion of the multi-lobe ring seal 22 and to constrain rotation of seal 22 when the seal 22 is situated in groove 20.

Referring to FIG. 3, at the bottom of the container 10, a skirt section 42 is provided. Additionally or alternatively, skirt section 42 may comprise an opening 15 to allow ambient air access to the power chamber 14.

Referring to FIGS. 1 and 3, a dispensing pump 24 is located at the opening 52 of the container 10. Release valve 26 within the dispensing pump 24 has an opening position and a closed position. A press button 27 is in communication with the valve 26, whereby depressing the press button 27 moves the valve 26 into an open position.

The container 10 may be made in any of a variety of manners. The container 10 may be made of plastic, glass, or any other material usable for storing a liquid. The liquid may include hand lotions, face creams, wrinkle serums, acne treatments, shampoos, conditioners and liquids for a host of applications. The liquid need only be capable of fluid dispensing as is disclosed herein. The container 10 may have a uniform cross section along a height 13 of the chamber 10 such that the piston 18 may have a similar dimension and be slideable along the height 13 of the container 10. The container 10 may be ornamentally designed.

The piston is positioned to bias the fluid toward the opening 52. As disclosed, with respect to the first exemplary embodiment of the invention, the opening 52 is at the top of the container 10, although the operation of the dispensing pump 24 only requires the opening 52 be located along the container 10 at a position distal from the piston 18.

The dispensing pump 24 is connected to the container 10 at the opening 52 of the container 10. In this manner, the dispensing pump 24 covers and seals the opening 52. A valve 26 is provided within the dispensing pump 24. The valve 26 has a closed position and an open position. The closed position of the valve 26 inhibits fluid from exiting the container 10. The open position of the valve 26 allows fluid to flow through the valve 26. The valve 26 is in communication with the press button 27. The valve 26 may be biased in the closed position. Similarly, the press button 27 may be biased and, communicatively, bias the valve 26 in the closed position. Biasing may be performed in any manner that is known to those having ordinary skill in the art. Dispensing pump 24 may also comprise a temporary holding chamber (not shown), wherein the airless pump is adapted to pressurize fluid within the holding chamber upon downward depression of the press button 27 to dispense the fluid from the nozzle 29, and also adapted to exert negative pressure on the liquid chamber 12 to suck fluid from the liquid chamber 12 into the holding chamber upon upward return of the press button 27.

During use, a user depresses the press button 27. Press button 27 then opens valve 26 expelling fluid from the valve 26 through the nozzle 29. As fluid is expelled, the piston is biased upward by the negative pressure exerted by the dispensing pump 24 on the liquid chamber 12. As the volume of chamber 14 expands, the negative pressure of the chamber 14 is filled with ambient air that is allowed to enter the chamber 14 from the opening 15 in the chamber 14 of the container 10.

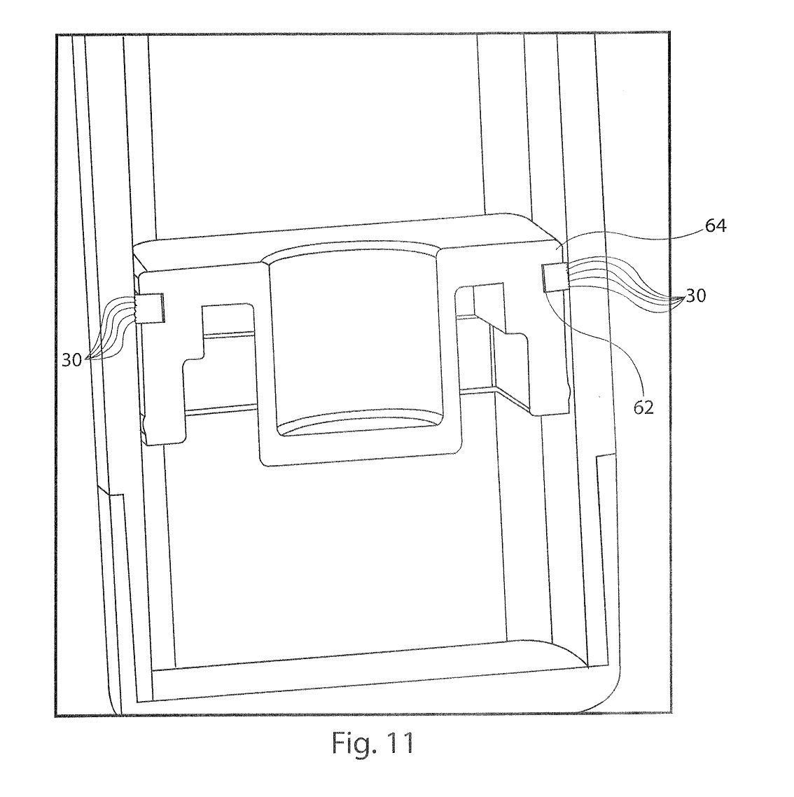

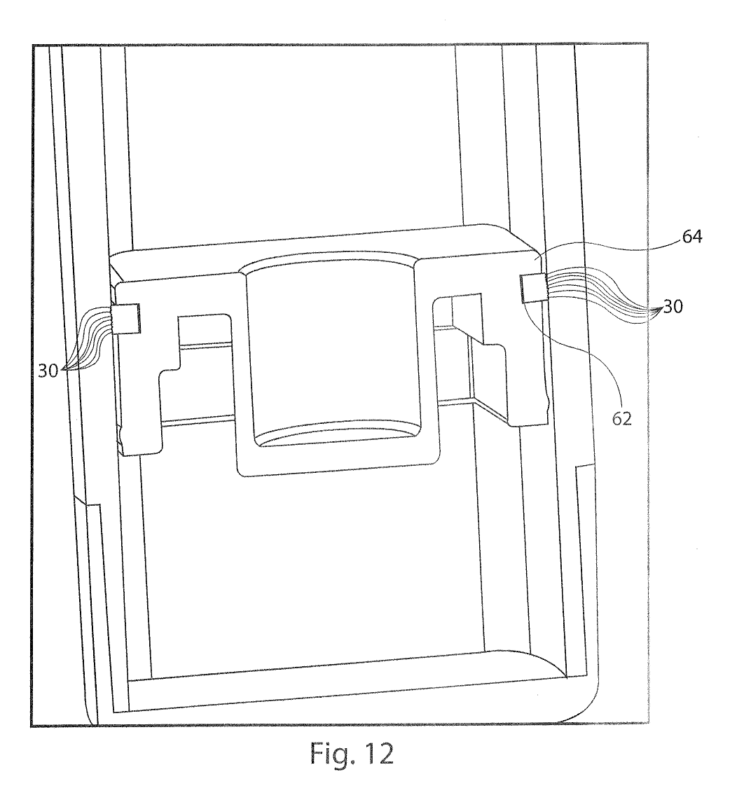

It should be emphasized that the above-described embodiments of the present invention, particularly, any “preferred” embodiments, are merely possible examples of implementations, merely set forth for a clear understanding of the principles of the invention. For example, referring to FIGS. 5-6, a multi-lobe ring seal may be formed in-situ in a circumferential groove 62 formed in a piston 64 using two shot or bi-injection technology. Simplistically this is accomplished by injecting a bead of silicon 66, or another suitable resin, into the groove, and shaping the outside (exposed) edge 70 of the bead in the form of a two lobe ring seal. Other variations and modifications may be made to the above-described embodiments of the invention without departing substantially from the spirit and principles of the invention. For example, the multi-lobe ring seal may be formed with any number of lobes, e.g. 2, 3, 4 or 5 or more lobes. All such modifications and variations are intended to be included herein within the scope of this disclosure and the present invention and protected by the following claims.

1. An airless pump container for dispensing fluid, comprising:
a first chamber for enclosing a fluid, wherein the first chamber has an interior with substantially uniform non-circular cross section along a height of the first chamber;
a release valve in fluid communication with the first chamber to release the fluid contents of the first chamber upon command; and
a second chamber, separated from the first chamber by a piston, wherein the piston comprises a cross section peripheral shape conforming to the substantially uniform cross section along the height of the first chamber and a channel in the circumference of the piston in which is situated a multi-lobe ring seal that seals a gap between the interior of the first chamber and the periphery of the piston and allows the piston to transverse the height of the first chamber, at least in part.

2. The container of claim 1, wherein the substantially uniform cross section shape of the chamber is substantially a polygon.

3. The container of claim 2, wherein the corners of the polygon are at least partially rounded.

4. The container of claim 2, wherein the polygon is a square.

5. The container of claim 1, wherein the second chamber is in fluid contact with ambient air.

6. The container of claim 1, wherein the piston further comprises a second channel in which is situated a second multi-lobe ring seal.

7. The container of claim 6, wherein the piston further comprises a third channel in which a lubricant is housed.

8. The container of claim 1, wherein the multi-lobe ring seal comprises a valley in which a lubricant is housed.

9. The container of claim 8, wherein the lubricant is comprised of at least one of the group consisting of oil, cream, and the fluid.

10. The container of claim 1, wherein the piston is driven, at least in part, by a negative pressure created by operation of the release valve.

11. The container of claim 1, wherein the fluid is a liquid such as a cosmetic product.

12. The container of claim 1, wherein the piston further comprises a face surface and a bottom surface and wherein the face surface has a pocket to accommodate the release valve as the piston approaches the release valve.

13. The container of claim 12, wherein the pocket extends beyond the bottom surface of the piston.

14. The container of claim 1, wherein the multi-lobe ring seal is formed in-situ in the channel.

15. The container of claim 1, wherein the multi-lobe ring seal is formed separately from the piston, and placed in the channel.

16. The container of claim 1, wherein the multi-lobe ring seal has five lobes extending from the channel.

17. The container of claim 1, wherein the multi-lobe ring seal has four lobes extending from the channel.

18. The container of claim 1, wherein the multi-lobe ring seal has three lobes extending from the channel.

19. The container of claim 1, wherein the multi-lobe ring seal has two lobes extending from the channel.

20. The container of claim 1, wherein the multi-lobe ring seal has an odd number of lobes extending from the channel selected from three, five and seven lobes.

21. A method of sealing the space between a piston and an interior of a chamber in an airless pump having a substantially uniform non-circular cross section along a height of the chamber comprising;
providing the piston with a shape that corresponds to the cross section of the chamber;
providing a channel in the piston that is configured to accommodate a multi-lobe ring seal having a valley;
placing the multi-lobe ring seal in the channel in the piston; and
placing the piston in the chamber.

22. The method of claim 21, wherein the cross section of the chamber is substantially a polygon.

23. The method of claim 22, wherein the corners of the polygon are rounded, at least in part.

24. The method of claim 21, further comprising providing a lubricant to the valley of the multi-lobe ring seal.

25. The method of claim 21, wherein the multi-lobe ring seal is formed in-situ in the channel.

26. The method of claim 21, wherein the multi-lobe ring seal is formed separately from the piston, and placed in the channel.

27. The method of claim 21, wherein the multi-lobe ring seal has four lobes extending from the channel.

28. The method of claim 21, wherein the multi-lobe ring seal has two lobes extending from the channel.

29. The method of claim 21, wherein the multi-lobe ring seal has an odd number of lobes extending from the channel selected from three, five and seven lobes.

30. A method of dispensing a fluid from an airless pump, comprising:
providing an airless pump having a chamber having an interior with a substantially uniform non-circular cross section along a height of the chamber;
a piston with a shape that corresponds to the cross section of the chamber; and
a channel in the piston that is configured to accommodate a multi-lobe ring seal having a valley;
placing the multi-lobe ring seal in the channel in the piston;
placing the piston in the chamber;
providing a release valve in fluid communication with the first chamber to release the fluid contents of the first chamber upon command; and operating the release valve to expel the fluid.

31. The method of claim 30, further comprising providing a lubricant to the valley of the multi-lobe ring seal.

32. The method of claim 31, wherein the lubricant is selected from the group consisting of an oil, a cream, and the fluid.

33. The method of claim 30, wherein the multi-lobe ring is formed in-situ in the channel.

34. The method of claim 30, wherein the multi-lobe ring is formed separately from the piston, and placed in the channel.

35. The method of claim 30, wherein the multi-lobe ring seal has four lobes extending from the channel.

36. The method of claim 30, wherein the multi-lobe ring seal has two lobes extending from the channel.

37. The method of claim 30, wherein the multi-lobe ring seal has an odd number of lobes extending from the channel selected from three, five and seven lobes.

38. A method of dispensing a fluid from an airless pump, comprising:
providing an airless pump having a chamber having an interior with a substantially uniform cross section along a height of the chamber;
a piston with a shape that corresponds to the cross section of the chamber; and
a channel in the piston that is configured to accommodate a multi-lobe ring seal having a valley;
forming the multi-lobe ring seal in situ in the channel in the piston;
placing the piston in the chamber;
providing a release valve in fluid communication with the first chamber to release the fluid contents of the first chamber upon command; and
operating the release valve to expel the fluid.
